(19) United States
(12) Patent Application Publication
(10) Pub. No.: US 2025/0119241 A1
(43) Pub. Date: Apr. 10, 2025

(54) METHOD AND APPARATUS FOR HARQ-ACK CODEBOOK DETERMINATION FOR TRANSPORT BLOCK REPETITION ON MULTIPLE CARRIERS

(71) Applicant: LENOVO (BEIJING) LIMITED, Beijing (CN)

(72) Inventors: Haipeng LEI, Beijing (CN); Yu ZHANG, Beijing (CN)

(21) Appl. No.: 18/832,399

(22) PCT Filed: Jan. 24, 2022
(86) PCT No.: PCT/CN2022/073493

§ 371 Date: Jul. 23, 2024

(51) Int. Cl. H04L 1/1812; H04W 72/232

(52) U.S. Cl. CPC H04L 1/1812; H04W 72/232

(57) ABSTRACT

Embodiments of the present disclosure relate to hybrid automatic repeat request acknowledgement (HARQ-ACK) codebook determination for carrier aggregation (CA). According to some embodiments of the disclosure, a UE may include: a transceiver configured to: receive a plurality of physical downlink shared channels (PDSCHs) on a plurality of carriers, wherein the plurality of PDSCHs is scheduled by a downlink control information (DCI) format; a processor coupled to the transceiver and configured to: determine a number of transport blocks (TBs) transmitted on the plurality of PDSCHs based on the DCI format; generate a HARQ-ACK codebook including a set of HARQ-ACK information bits for the TBs transmitted on the plurality of PDSCHs; and wherein the transceiver is further configured to transmit the HARQ-ACK codebook.

### TECHNICAL FIELD

Embodiments of the present disclosure generally relate to wireless communication technology, and more particularly to hybrid automatic repeat request acknowledgement (HARQ-ACK) codebook determination for carrier aggregation (CA).

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, a base station (BS) may transmit data signals to a user equipment (UE) via a physical downlink shared channel (PDSCH). In order to increase the data rate, CA technology may be used in the wireless communication system. For example, CA technology may refer to aggregating spectrum resources (e.g., carriers) from the same frequency band or different frequency bands for a UE. When CA technology is used, a plurality of PDSCHs may be transmitted on a plurality of carriers.

The UE may transmit HARQ-ACK feedback for the plurality of PDSCHs in a HARQ-ACK codebook. Accordingly, there is a need for handling HARQ-ACK codebook determination for CA in a wireless communication system.

### SUMMARY

Some embodiments of the present disclosure provide a UE. The UE may include: a transceiver configured to: receive a plurality of PDSCHs on a plurality of carriers, wherein the plurality of PDSCHs is scheduled by a downlink control information (DCI) format; a processor coupled to the transceiver and configured to: determine a number of transport blocks (TBs) transmitted on the plurality of PDSCHs based on the DCI format; generate a HARQ-ACK codebook including a set of HARQ-ACK information bits for the TBs transmitted on the plurality of PDSCHs; and wherein the transceiver is further configured to transmit the HARQ-ACK codebook.

In some embodiments of the present disclosure, the transceiver is further configured to receive a time domain resource allocation (TDRA) table, wherein a first entry of the TDRA table indicates multiple SLIVs, at least one slot offset value associated with the multiple SLIVs, and at least one PDSCH mapping type associated with the multiple SLIVs, and wherein each SLIV is associated with a corresponding PDSCH on a carrier of the plurality of carriers.

In some embodiments of the present disclosure, the first entry of the TDRA table further indicates a number of TBs.

In some embodiments of the present disclosure, the DCI format indicates the first entry of the TDRA table and determining the number of TBs based on the DCI format comprises determining the number of TBs based on the first entry.

In some embodiments of the present disclosure, the DCI format indicates whether the plurality of PDSCHs carries the same TB or each of the plurality of PDSCHs carries a different TB.

In some embodiments of the present disclosure, the set of HARQ-ACK information bits is placed in the HARQ-ACK codebook based on a downlink assignment indicator (DAI) in the DCI format.

In some embodiments of the present disclosure, a first HARQ-ACK information bit of the set of HARQ-ACK information bits is placed in the HARQ-ACK codebook according to the DAI in the DCI format, and the remaining HARQ-ACK information bit(s) of the set of HARQ-ACK information bits is placed following the first HARQ-ACK information bit.

In some embodiments of the present disclosure, in response to determining the number of TBs being equal to 1, the set of HARQ-ACK information bits only includes a HARQ-ACK information bit for the TB transmitted on the plurality of PDSCHs.

In some embodiments of the present disclosure, in response to determining the number of TBs being larger than 1 and smaller than a number of the plurality of carriers, the plurality of carriers includes a first set of carriers each of which carries a different TB, and a second set of carriers each of which carries a same TB.

In some embodiments of the present disclosure, the first set of carriers includes X carriers of the plurality of carriers and the second set of carriers includes the remaining carriers of the plurality of carriers, and wherein X equals the number of TBs minus 1.

In some embodiments of the present disclosure, the processor is further configured to perform at least one of the following: determining the first set of carriers to be carriers corresponding to the first X SLIVs in an entry of a TDRA table indicated by the DCI format; determining the first set of carriers to be carriers corresponding to the last X SLIVs in the entry of the TDRA table indicated by the DCI format; determining the first set of carriers to be carriers with X lowest serving cell indexes among carriers corresponding to SLIVs in the entry of the TDRA table indicated by the DCI format; determining the first set of carriers to be carriers with X highest serving cell indexes among carriers corresponding to SLIVs in the entry of the TDRA table indicated by the DCI format; determining a first carrier of the first set of carriers to be a carrier where the DCI format is transmitted and determine the remaining carrier(s) of the first set of carriers to be carriers immediately following the first carrier according to a pre-defined order of the serving cell indexes among carriers corresponding to SLIVs in the entry of the TDRA table indicated by the DCI format; determining the second set of carriers to be carriers corresponding to the first Y SLIVs in the entry of the TDRA table indicated by the DCI format, wherein Y is the number of carriers in the second set of carriers; determining the second set of carriers to be carriers corresponding to the last Y SLIVs in the entry of the TDRA table indicated by the DCI format; determining the second set of carriers to be carriers with Y lowest serving cell indexes among carriers corresponding to SLIVs in the entry of the TDRA table indicated by the DCI format; determining the second set of carriers to be carriers with Y highest serving cell indexes among carriers corresponding to SLIVs in the entry of the TDRA table indicated by the DCI format; or determining a second carrier of the second set of carriers to be a carrier where the DCI format is transmitted and determine the remaining carriers of the second set of carriers to be carriers immediately following the second carrier according to a pre-defined order of serving cell indexes among carriers corresponding to SLIVs in the entry of the TDRA table indicated by the DCI format.

In some embodiments of the present disclosure, the set of HARQ-ACK information bits includes a first HARQ-ACK information bit(s) for the TB(s) transmitted on the first set of carriers and a second HARQ-ACK information bit for the same TB transmitted on the second set of carriers.

In some embodiments of the present disclosure, the second HARQ-ACK information bit is placed at a pre-defined position of the set of HARQ-ACK information bits, and wherein the first HARQ-ACK information bit(s) are placed according to a pre-defined order of the serving cell indexes of the first set of carriers.

In some embodiments of the present disclosure, the set of HARQ-ACK information bits is ordered according to a pre-defined order of associated serving cell indexes of the plurality of carriers, and wherein the second HARQ-ACK information bit is associated with a specific serving cell index of the second set of carriers.

In some embodiments of the present disclosure, in response to determining the number of TBs being equal to a number of the plurality of carriers, the set of HARQ-ACK information bits is ordered according to a pre-defined order of associated serving cell indexes of the plurality of carriers.

In some embodiments of the present disclosure, the set of HARQ-ACK information bits is included in a sub-codebook.

Some other embodiments of the present disclosure provide a BS. The BS may include: a processor configured to: determine a number of TBs to be transmitted on a plurality of PDSCHs; a transceiver coupled to the processor and configured to: transmit the plurality of PDSCHs on a plurality of carriers, wherein the plurality of PDSCHs is scheduled by a DCI format; and receive a HARQ-ACK codebook including a set of HARQ-ACK information bits for the TBs transmitted on the plurality of PDSCHs.

In some embodiments of the present disclosure, the transceiver is further configured to transmit a TDRA table, wherein a first entry of the TDRA table indicates multiple SLIVs, at least one slot offset value associated with the multiple SLIVs, and at least one PDSCH mapping type associated with the multiple SLIVs, and wherein each SLIV is associated with a corresponding PDSCH on a carrier of the plurality of carriers.

In some embodiments of the present disclosure, the first entry of the TDRA table further indicates a number of TBs.

In some embodiments of the present disclosure, the DCI format indicates the first entry of the TDRA table and wherein the number of TBs is determined based on the first entry.

In some embodiments of the present disclosure, the DCI format indicates whether the plurality of PDSCHs carries the same TB or each of the plurality of PDSCHs carries a different TB.

In some embodiments of the present disclosure, the set of HARQ-ACK information bits is placed in the HARQ-ACK codebook based on a DAI in the DCI format.

In some embodiments of the present disclosure, a first HARQ-ACK information bit of the set of HARQ-ACK information bits is placed in the HARQ-ACK codebook according to the DAI in the DCI format, and the remaining HARQ-ACK information bit(s) of the set of HARQ-ACK information bits is placed following the first HARQ-ACK information bit.

In some embodiments of the present disclosure, in response to determining the number of TBs being equal to 1, the set of HARQ-ACK information bits only includes a HARQ-ACK information bit for the TB transmitted on the plurality of PDSCHs.

In some embodiments of the present disclosure, in response to determining the number of TBs being larger than 1 and smaller than a number of the plurality of carriers, the plurality of carriers includes a first set of carriers each of which carries a different TB, and a second set of carriers each of which carries a same TB.

In some embodiments of the present disclosure, the first set of carriers includes X carriers of the plurality of carriers and the second set of carriers includes the remaining carriers of the plurality of carriers, and wherein X equals the number of TBs minus 1.

In some embodiments of the present disclosure, the first set of carriers are carriers corresponding to the first X SLIVs in an entry of a TDRA table indicated by the DCI format; the first set of carriers are carriers corresponding to the last X SLIVs in the entry of the TDRA table indicated by the DCI format; the first set of carriers are carriers with X lowest serving cell indexes among carriers corresponding to SLIVs in the entry of the TDRA table indicated by the DCI format; the first set of carriers are carriers with X highest serving cell indexes among carriers corresponding to SLIVs in the entry of the TDRA table indicated by the DCI format; or a first carrier of the first set of carriers is a carrier where the DCI format is transmitted and remaining carrier(s) of the first set of carriers are carriers immediately following the first carrier according a pre-defined order of serving cell indexes among carriers corresponding to SLIVs in the entry of the TDRA table indicated by the DCI format; the second set of carriers are carriers corresponding to the first Y SLIVs in the entry of the TDRA table indicated by the DCI format, wherein Y is the number of carriers in the second set of carriers; the second set of carriers are carriers corresponding to the last Y SLIVs in the entry of the TDRA table indicated by the DCI format; the second set of carriers are carriers with Y lowest serving cell indexes among carriers corresponding to SLIVs in the entry of the TDRA table indicated by the DCI format; the second set of carriers are carriers with Y highest serving cell indexes among carriers corresponding to SLIVs in the entry of the TDRA table indicated by the DCI format; or a second carrier of the second set of carriers is a carrier where the DCI format is transmitted and the remaining carriers of the second set of carriers are carriers immediately following the second carrier according to a pre-defined order of serving cell indexes among carriers corresponding to SLIVs in the entry of the TDRA table indicated by the DCI format.

In some embodiments of the present disclosure, the set of HARQ-ACK information bits includes a first HARQ-ACK information bit(s) for the TB(s) transmitted on the first set of carriers and a second HARQ-ACK information bit for the same TB transmitted on the second set of carriers.

In some embodiments of the present disclosure, the second HARQ-ACK information bit is placed at a pre-defined position of the set of HARQ-ACK information bits, and wherein the first HARQ-ACK information bit(s) are placed according to a pre-defined order of the serving cell indexes of the first set of carriers.

In some embodiments of the present disclosure, the set of HARQ-ACK information bits is ordered according to a pre-defined order of associated serving cell indexes of the plurality of carriers, and wherein the second HARQ-ACK information bit(s) is associated with a specific serving cell index of the second set of carriers.

In some embodiments of the present disclosure, in response to determining the number of TBs being equal to a number of the plurality of carriers, the set of HARQ-ACK information bits is ordered according to a pre-defined order of associated serving cell indexes of the plurality of carriers.

In some embodiments of the present disclosure, the set of HARQ-ACK information bits is included in a sub-codebook.

Some embodiments of the present disclosure provide a method performed by a UE. The method may include: receiving a plurality of PDSCHs on a plurality of carriers, wherein the plurality of PDSCHs is scheduled by a DCI format; determining a number of TBs transmitted on the plurality of PDSCHs based on the DCI format; generating a HARQ-ACK codebook including a set of HARQ-ACK information bits for the TBs transmitted on the plurality of PDSCHs; and transmitting the HARQ-ACK codebook.

In some embodiments of the present disclosure, the method may further include: receiving a TDRA table, wherein a first entry of the TDRA table indicates multiple SLIVs, at least one slot offset value associated with the multiple SLIVs, and at least one PDSCH mapping type associated with the multiple SLIVs, and wherein each SLIV is associated with a corresponding PDSCH on a carrier of the plurality of carriers.

In some embodiments of the present disclosure, the first entry of the TDRA table further indicates a number of TBs.

In some embodiments of the present disclosure, the DCI format indicates the first entry of the TDRA table and determining the number of TBs based on the DCI format comprises determining the number of TBs based on the first entry.

In some embodiments of the present disclosure, the DCI format indicates whether the plurality of PDSCHs carries the same TB or each of the plurality of PDSCHs carries a different TB.

In some embodiments of the present disclosure, the set of HARQ-ACK information bits is placed in the HARQ-ACK codebook based on a downlink assignment indicator (DAI) in the DCI format.

In some embodiments of the present disclosure, a first HARQ-ACK information bit of the set of HARQ-ACK information bits is placed in the HARQ-ACK codebook according to the DAI in the DCI format, and the remaining HARQ-ACK information bit(s) of the set of HARQ-ACK information bits is placed following the first HARQ-ACK information bit.

In some embodiments of the present disclosure, in response to determining the number of TBs being equal to 1, the set of HARQ-ACK information bits only includes a HARQ-ACK information bit for the TB transmitted on the plurality of PDSCHs.

In some embodiments of the present disclosure, in response to determining the number of TBs being larger than 1 and smaller than a number of the plurality of carriers, the plurality of carriers includes a first set of carriers each of which carries a different TB, and a second set of carriers each of which carries a same TB.

In some embodiments of the present disclosure, the first set of carriers includes X carriers of the plurality of carriers and the second set of carriers includes the remaining carriers of the plurality of carriers, and wherein X equals the number of TBs minus 1.

In some embodiments of the present disclosure, the method may further include: performing at least one of the following: determining the first set of carriers to be carriers corresponding to the first X SLIVs in an entry of a TDRA table indicated by the DCI format; determining the first set of carriers to be carriers corresponding to the last X SLIVs in the entry of the TDRA table indicated by the DCI format; determining the first set of carriers to be carriers with X lowest serving cell indexes among carriers corresponding to SLIVs in the entry of the TDRA table indicated by the DCI format; determining the first set of carriers to be carriers with X highest serving cell indexes among carriers corresponding to SLIVs in the entry of the TDRA table indicated by the DCI format; determining a first carrier of the first set of carriers to be a carrier where the DCI format is transmitted and determine the remaining carrier(s) of the first set of carriers to be carriers immediately following the first carrier according to a pre-defined order of the serving cell indexes among carriers corresponding to SLIVs in the entry of the TDRA table indicated by the DCI format; determining the second set of carriers to be carriers corresponding to the first Y SLIVs in the entry of the TDRA table indicated by the DCI format, wherein Y is the number of carriers in the second set of carriers; determining the second set of carriers to be carriers corresponding to the last Y SLIVs in the entry of the TDRA table indicated by the DCI format; determining the second set of carriers to be carriers with Y lowest serving cell indexes among carriers corresponding to SLIVs in the entry of the TDRA table indicated by the DCI format; determining the second set of carriers to be carriers with Y highest serving cell indexes among carriers corresponding to SLIVs in the entry of the TDRA table indicated by the DCI format; or determining a second carrier of the second set of carriers to be a carrier where the DCI format is transmitted and determine the remaining carriers of the second set of carriers to be carriers immediately following the second carrier according to a pre-defined order of serving cell indexes among carriers corresponding to SLIVs in the entry of the TDRA table indicated by the DCI format.

In some embodiments of the present disclosure, the set of HARQ-ACK information bits includes a first HARQ-ACK information bit(s) for the TB(s) transmitted on the first set of carriers and a second HARQ-ACK information bit for the same TB transmitted on the second set of carriers.

In some embodiments of the present disclosure, the second HARQ-ACK information bit is placed at a pre-defined position of the set of HARQ-ACK information bits, and wherein the first HARQ-ACK information bit(s) are placed according to a pre-defined order of the serving cell indexes of the first set of carriers.

In some embodiments of the present disclosure, the set of HARQ-ACK information bits is ordered according to a pre-defined order of associated serving cell indexes of the plurality of carriers, and wherein the second HARQ-ACK information bit is associated with a specific serving cell index of the second set of carriers.

In some embodiments of the present disclosure, in response to determining the number of TBs being equal to a number of the plurality of carriers, the set of HARQ-ACK information bits is ordered according to a pre-defined order of associated serving cell indexes of the plurality of carriers.

In some embodiments of the present disclosure, the set of HARQ-ACK information bits is included in a sub-codebook.

Some other embodiments of the present disclosure provide a method performed by a BS. The method may include: determining a number of TBs to be transmitted on a plurality of PDSCHs; transmitting the plurality of PDSCHs on a plurality of carriers, wherein the plurality of PDSCHs is scheduled by a DCI format; and receiving a HARQ-ACK codebook including a set of HARQ-ACK information bits for the TBs transmitted on the plurality of PDSCHs.

In some embodiments of the present disclosure, the method may further include: transmitting a TDRA table, wherein a first entry of the TDRA table indicates multiple SLIVs, at least one slot offset value associated with the multiple SLIVs, and at least one PDSCH mapping type associated with the multiple SLIVs, and wherein each SLIV is associated with a corresponding PDSCH on a carrier of the plurality of carriers.

In some embodiments of the present disclosure, the first entry of the TDRA table further indicates a number of TBs.

In some embodiments of the present disclosure, the DCI format indicates the first entry of the TDRA table and wherein the number of TBs is determined based on the first entry.

In some embodiments of the present disclosure, the DCI format indicates whether the plurality of PDSCHs carries the same TB or each of the plurality of PDSCHs carries a different TB.

In some embodiments of the present disclosure, the set of HARQ-ACK information bits is placed in the HARQ-ACK codebook based on a DAI in the DCI format.

In some embodiments of the present disclosure, a first HARQ-ACK information bit of the set of HARQ-ACK information bits is placed in the HARQ-ACK codebook according to the DAI in the DCI format, and the remaining HARQ-ACK information bit(s) of the set of HARQ-ACK information bits is placed following the first HARQ-ACK information bit.

In some embodiments of the present disclosure, in response to determining the number of TBs being equal to 1, the set of HARQ-ACK information bits only includes a HARQ-ACK information bit for the TB transmitted on the plurality of PDSCHs.

In some embodiments of the present disclosure, in response to determining the number of TBs being larger than 1 and smaller than a number of the plurality of carriers, the plurality of carriers includes a first set of carriers each of which carries a different TB, and a second set of carriers each of which carries a same TB.

In some embodiments of the present disclosure, the first set of carriers includes X carriers of the plurality of carriers and the second set of carriers includes the remaining carriers of the plurality of carriers, and wherein X equals the number of TBs minus 1.

In some embodiments of the present disclosure, the first set of carriers are carriers corresponding to the first X SLIVs in an entry of a TDRA table indicated by the DCI format; the first set of carriers are carriers corresponding to the last X SLIVs in the entry of the TDRA table indicated by the DCI format; the first set of carriers are carriers with X lowest serving cell indexes among carriers corresponding to SLIVs in the entry of the TDRA table indicated by the DCI format; the first set of carriers are carriers with X highest serving cell indexes among carriers corresponding to SLIVs in the entry of the TDRA table indicated by the DCI format; or a first carrier of the first set of carriers is a carrier where the DCI format is transmitted and remaining carrier(s) of the first set of carriers are carriers immediately following the first carrier according a pre-defined order of serving cell indexes among carriers corresponding to SLIVs in the entry of the TDRA table indicated by the DCI format; the second set of carriers are carriers corresponding to the first Y SLIVs in the entry of the TDRA table indicated by the DCI format, wherein Y is the number of carriers in the second set of carriers; the second set of carriers are carriers corresponding to the last Y SLIVs in the entry of the TDRA table indicated by the DCI format; the second set of carriers are carriers with Y lowest serving cell indexes among carriers corresponding to SLIVs in the entry of the TDRA table indicated by the DCI format; the second set of carriers are carriers with Y highest serving cell indexes among carriers corresponding to SLIVs in the entry of the TDRA table indicated by the DCI format; or a second carrier of the second set of carriers is a carrier where the DCI format is transmitted and the remaining carriers of the second set of carriers are carriers immediately following the second carrier according to a pre-defined order of serving cell indexes among carriers corresponding to SLIVs in the entry of the TDRA table indicated by the DCI format.

In some embodiments of the present disclosure, the set of HARQ-ACK information bits includes a first HARQ-ACK information bit(s) for the TB(s) transmitted on the first set of carriers and a second HARQ-ACK information bit for the same TB transmitted on the second set of carriers.

In some embodiments of the present disclosure, the second HARQ-ACK information bit is placed at a pre-defined position of the set of HARQ-ACK information bits, and wherein the first HARQ-ACK information bit(s) are placed according to a pre-defined order of the serving cell indexes of the first set of carriers.

In some embodiments of the present disclosure, the set of HARQ-ACK information bits is ordered according to a pre-defined order of associated serving cell indexes of the plurality of carriers, and wherein the second HARQ-ACK information bit(s) is associated with a specific serving cell index of the second set of carriers.

In some embodiments of the present disclosure, in response to determining the number of TBs being equal to a number of the plurality of carriers, the set of HARQ-ACK information bits is ordered according to a pre-defined order of associated serving cell indexes of the plurality of carriers.

In some embodiments of the present disclosure, the set of HARQ-ACK information bits is included in a sub-codebook.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 is a flow chart illustrating an exemplary method for HARQ-ACK codebook determination according to some embodiments of the present application;

FIG. 3 is a flow chart illustrating another exemplary method for HARQ-ACK codebook determination according to some other embodiments of the present application; and

FIG. 4 illustrates a simplified block diagram of an exemplary apparatus for HARQ-ACK codebook determination according to some embodiments of the present application.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

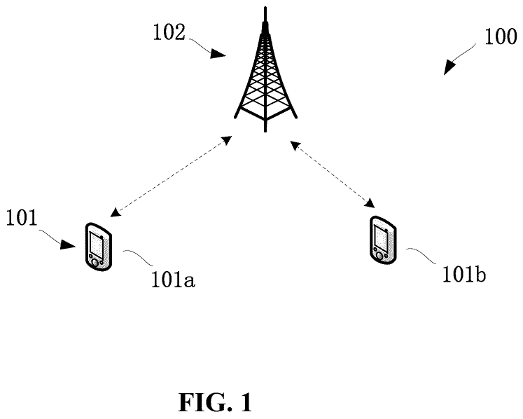

FIG. 1 illustrates a schematic diagram of a wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

NR supports a wide range of spectrums in different frequency ranges. In the market for 5G Advanced, it is expected that the availability of the spectrum will be increased, which is possibly due to re-farming the bands originally used for previous cellular generation networks. For example, for some low frequency bands of FR1 (e.g., 450 MHz-6000 MHz), the available spectrum bands tend to be more fragmented and scattered with a narrower bandwidth. In addition, for bands of FR2 (24250 MHz-52600 MHz) and some bands of FR1 (frequency range 1), the available spectrum may be wider such that an intra-band multi-carrier operation is necessary.

To meet different spectrum needs, it is important to ensure that these fragmented or scattered spectrum bands or spectrums with wider bandwidth are utilized in a more spectrum and power efficient and flexible manner, thereby providing higher throughput and decent coverage in the network.

For example, one motivation is to increase spectrum/power efficiency and flexibility on scheduling data over multiple cells including intra-band cells and inter-band cells. In some examples, scheduling mechanisms may only allow scheduling a single PUSCH or PDSCH on a single cell per a scheduling DCI. As more scattered spectrum bands or spectrums with wider bandwidth becomes available, it is advisable to allow simultaneous scheduling of multiple cells.

NR is designed to support a max of 16 component carriers (CCs) in the case of CA or a max of 32 CCs in the case of dual connectively (DC). In some embodiments of the present application, in the case of CA, one DCI can schedule at most one carrier by cross-carrier scheduling or self-scheduling. This requires much signaling overhead for PDCCHs to schedule PDSCHs when the number of carriers configured for a UE is large. To reduce signaling overhead, it is beneficial to use a single DCI to schedule multiple PDSCHs or PUSCHs on multiple carriers configured to the UE.

When using a single DCI scheduling multiple PDSCHs on multiple carriers, it is quite flexible to dynamically control the number of TBs on the scheduled carriers so as to reach a tradeoff between reliability and peak data rate. For example, for the purpose of increasing reliability, a single DCI may schedule one TB on multiple carriers such that each carrier may be used to transmit a TB repetition. For the purpose of increasing peak data rate, a single DCI may schedule multiple different TBs on multiple carriers such that each carrier may be used to transmit a different TB. Given this, how to dynamically indicate the number of TBs transmitted on the multiple carriers to a UE needs to be addressed.

In addition, for multiple PDSCHs on multiple carriers, the UE may transmit HARQ-ACK feedback to the BS. Given this, how to determine HARQ-ACK feedback for multiple PDSCHs carrying a number of TBs needs to be addressed.

Moreover, HARQ-ACK feedback corresponding to multiple PDSCHs may be multiplexed in one HARQ-ACK codebook and transmitted on one carrier, e.g., on a primary cell (PCell) or primary secondary cell (PSCell). How to determine the HARQ-ACK codebook according to the DAIs in the DCI formats needs to be addressed.

Given the above, embodiments of the present application propose solutions for HARQ-ACK codebook determination for CA, which can at least solve the above technical problems. More details on the embodiments of the present application will be illustrated in the following text in combination with the appended drawings.

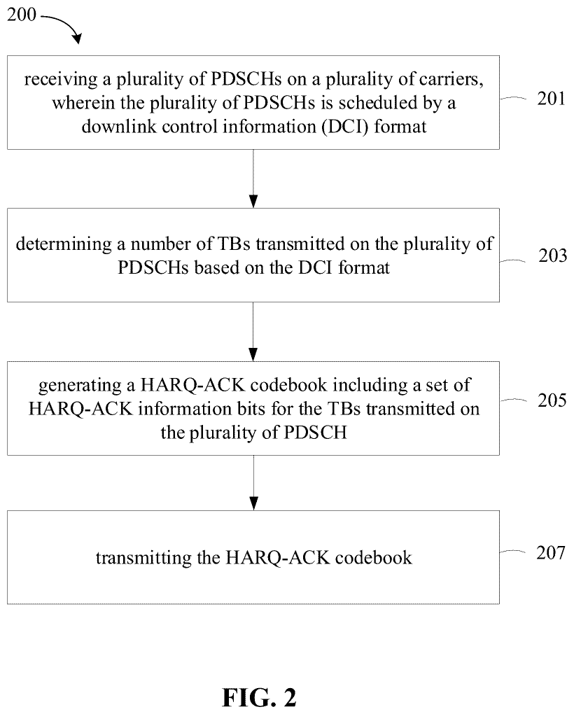

FIG. 2 is a flow chart illustrating an exemplary method 200 for HARQ-ACK codebook determination according to some embodiments of the present application. The method in FIG. 2 may be implemented by a UE (e.g., UE 101 as shown in FIG. 1).

In the exemplary method shown in FIG. 2, in step 201, the UE may receive a plurality of PDSCHs on a plurality of carriers from a BS (e.g., BS 102 as shown in FIG. 1). The plurality of PDSCHs may be scheduled by a DCI format (e.g., DCI format 1_0 or DCI format 1_1 as specified in 3GPP standard documents). The plurality of PDSCHs may carry a number of TBs.

The number of the plurality of PDSCHs may be the same as the number of the plurality of carriers, and each PDSCH of the plurality of PDSCHs may be scheduled on a corresponding carrier of the plurality of carriers. Each carrier may correspond to a serving cell (also referred to as “a cell”) having a serving cell index (also referred to as “a cell index”).

In step 203, the UE may determine the number of TBs transmitted on the plurality of PDSCHs based on the DCI format.

According to some embodiments of the present application, the UE may be configured with a TDRA table, and the number of TBs may be determined based on the TDRA table. For example, before receiving the DCI format scheduling the plurality of PDSCHs, the UE may receive a TDRA table. The TDRA table may include one or more entries. At least one entry of the one or more entries may include:
Multiple SLIVs. Each SLIV of the multiple SLIVs is associated with a corresponding PDSCH on a scheduled carrier. In other words, each SLIV of the multiple SLIVs is associated with a corresponding scheduled carrier. Accordingly, the number of SLIVs is equal to the number of scheduled PDSCHs and the number of scheduled carriers. In an embodiment of the present application, the number of SLIVs within one entry may be 1, 2, 3, 4, 5, 6, 7, 8, 10, 12, 14, 16, or any other values.
At least one slot offset value (e.g., K0 as specified in 3GPP standard documents) associated with the multiple SLIVs. In some embodiments, the number of the at least one slot offset value may be less than or equal to the number of multiple SLIVs. In some examples, each SLIV may be associated with a corresponding slot offset value.
At least one PDSCH mapping type (e.g., PDSCH mapping type A and/or PDSCH mapping type B as specified in 3GPP standard documents) associated with the multiple SLIVs. In some embodiments, the number of the at least one PDSCH mapping type may be less than or equal to the number of multiple SLIVs. In some examples, each SLIV may be associated with a corresponding PDSCH mapping type.

In some embodiments of the present application, at least one entry of the one or more entries may indicate the numbers of TBs. For example, an entry of the one or more entries may include a field indicating a number of TBs for the multiple SLIVs in this entry. In some embodiments of the present application, the number of TBs of an entry with multiple SLIVs can be 1, 2, 3, 4, 5, 6, 7, 8, 10, 12, 14, 16 or other values.

The DCI format scheduling the plurality of PDSCHs (e.g., a TDRA field in a DCI format) may indicate an entry (e.g., entry #0) of the TDRA table. Consequently, in response to receiving the DCI format, the UE may determine entry #0 indicated by the DCI format. In some examples, the UE may determine the number of TBs transmitted on the plurality of PDSCHs to be the number of TBs indicated by entry #0 (e.g., indicated by the field in the entry #0), determine the number of the plurality of PDSCHs and the number of the plurality of carriers to be the number of multiple SLIVs in entry #0, and determine the plurality of carriers scheduled by the DCI format to be carriers corresponding to multiple SLIVs in entry #0.

In step 205, the UE may generate a HARQ-ACK codebook. The HARQ-ACK codebook may include a set of HARQ-ACK information bits for the TBs transmitted on the plurality of PDSCHs.

In some embodiments of the present application, the set of HARQ-ACK information bits is placed in the HARQ-ACK codebook based on a DAI in the DCI format.

For example, the DCI format may include a DAI (e.g., a counter DAI) to indicate the accumulative number of transmitted DCI formats with a cyclic redundancy check (CRC) scrambled by a cell radio network temporary identifier (C-RNTI) for scheduling a dynamic PDSCH transmission, activating semi-persistent scheduling (SPS) PDSCH transmission, releasing SPS PDSCH transmission, or indicating secondary cell (SCell) dormancy, up to a current serving cell and current PDCCH monitoring occasion. The DCI format may also include an additional DAI (e.g., a total DAI) to indicate the total number of transmitted DCI formats with CRC scrambled by a C-RNTI for scheduling a dynamic PDSCH transmission, activating SPS PDSCH transmission, releasing SPS PDSCH transmission, or indicating SCell dormancy, up to the current PDCCH monitoring occasion.

In the case that the HARQ-ACK codebook includes HARQ-ACK feedback (e.g., the set of HARQ-ACK information bits) corresponding to the plurality of PDSCHs scheduled by the DCI format and HARQ-ACK feedback corresponding to PDSCHs scheduled by one or more other DCI formats, the HARQ-ACK codebook may be determined based the DAIs in these DCI formats. For example, the size of the HARQ-ACK codebook may be determined based on the total DAI. For example, the set of HARQ-ACK information bits may be placed in the HARQ-ACK codebook based on the counter DAI in the DCI format.

In some embodiments of the present application, the UE may determine that the number of TBs transmitted on the plurality of PDSCHs is equal to 1. That is, each of the plurality of scheduled carriers transmits the same TB (e.g., each carrier may transmit a TB repetition of the same TB). In other words, a single TB is repeatedly transmitted on all the plurality of carriers (e.g., all the scheduled PDSCHs). The set of HARQ-ACK information bits for the number of TBs may only include a single HARQ-ACK information bit (e.g., ACK or NACK) for the same TB (for example, when code block group (CBG) based retransmission, spatial bundling and the maximum of 2 TBs per PDSCH are not configured). Specifically, as long as one PDSCH of the plurality of PDSCHs is correctly received or decoded by the UE, then an ACK is generated for the repeatedly transmitted TB; and only when all of the plurality of PDSCHs are not correctly received or decoded, a NACK is generated for the TB. In this case, the UE may place the single HARQ-ACK information bit in the HARQ-ACK codebook according to the value of the DAI (e.g., counter DAI) in the DCI format.

In some embodiments of the present application, the UE may determine that the number of TBs is larger than 1 and smaller than the number of the plurality of carriers. In such embodiments, the plurality of carriers may include a set of carriers (e.g., carrier set #1), each of which carries a different TB, and another set of carriers (e.g., carrier set #2), each of which carries the same TB. Carrier set #1 may include X carriers of the plurality of carriers wherein X equals the number of TBs minus 1. Carrier set #2 may include the remaining carriers of the plurality of carriers, and the number of carriers in carrier set #2 is denoted as Y for clarity.

For example, it is assumed that an entry (e.g., entry #0) indicated by the DCI format indicates M TBs and N SLIVs (each SLIV may correspond to a corresponding carrier). The UE may determine that the number of TBs scheduled by the DCI format is M and the number of the plurality of carriers is N. When M is smaller than N, carrier set #1 may include M−1 carriers (i.e., X=M−1) each of which carries a different TB, and carrier set #2 may include N−M+1 carriers (i.e., Y=N−M+1), each of which carries the same TB (e.g., carrying a TB repetition of the same TB).

The UE may perform at least one of the following operations to determine carrier set #1 and carrier set #2.

In some embodiments of the present application, the UE may determine that carrier set #1 or carrier set #2 to be carriers corresponding to certain specific SLIVs in the entry of the TDRA table indicated by the DCI format.

For example, in an embodiment of the present application, the UE may determine carrier set #1 to be carriers corresponding to the first M−1 SLIVs in the entry of the TDRA table indicated by the DCI format. For example, it is assumed that when N=10 and M=5, then carrier set #1 may include 4 carriers corresponding to the first 4 SLIVs in the entry #0. After determining carrier set #1, carrier set #2 may include the remaining 6 carriers corresponding to the remaining 6 SLIVs.

In another embodiment of the present application, the UE may determine carrier set #1 to be carriers corresponding to the last M−1 SLIVs in the entry of the TDRA table indicated by the DCI format. For example, it is assumed that when N=10 and M=5, then carrier set #1 may include 4 carriers corresponding to the last 4 SLIVs in the entry #0. After determining carrier set #1, carrier set #2 may include the remaining 6 carriers corresponding to the remaining 6 SLIVs.

In yet another embodiment of the present application, the UE may determine carrier set #1 to be carriers with M−1 lowest serving cell indexes among carriers corresponding to SLIVs in the entry of the TDRA table indicated by the DCI format. For example, it is assumed that N=10 and M=5, and the N carriers are denoted as carrier #1 to carrier #10, which correspond to cell indexes #1 to #10, respectively. Then, carrier set #1 may include carriers #1 to #4 which correspond to cell indexes #1 to #4, and carrier set #2 may include the remaining carriers #5 to #10.

In yet another embodiment of the present application, the UE may determine carrier set #1 to be carriers with M−1 highest serving cell indexes among carriers corresponding to SLIVs in the entry of the TDRA table indicated by the DCI format. For example, it is assumed that N=10 and M=5, and the N carriers are denoted as carrier #1 to carrier #10, which correspond to cell indexes #1 to #10, respectively. Then, carrier set #1 may include carriers #7 to #10 which correspond to cell indexes #7 to #10, and carrier set #2 may be the remaining carriers #1 to #6.

In yet another embodiment of the present application, the UE may determine one (e.g., carrier #1A) of carrier set #1 to be a carrier where the DCI format is transmitted and determine the remaining carrier(s) of carrier set #1 to be carriers immediately following carrier #1A according to a pre-defined order (e.g., an ascending order, an descending order, or any other order) of the serving cell indexes among carriers corresponding to SLIVs in the entry of the TDRA table indicated by the DCI format. For example, it is assumed that N=10 and M=5, the N carriers are denoted as carrier #1 to carrier #10, which correspond to cell indexes #1 to #10, respectively, the DCI format is transmitted on carrier #2, and the pre-defined order is an ascending order. Then, the UE may determine carrier #1A to be carrier #2, and determine the remaining 3 carriers of carrier set #1 to be carriers #3 to #5 which immediately follow carrier #2 according to an ascending order of the serving cell indexes. Carrier set #2 may be the remaining carriers #1 and #6-#10.

In yet another embodiment of the present application, the UE may determine carrier set #2 to be carriers corresponding to the first N−M+1 SLIVs in the entry of the TDRA table indicated by the DCI format. For example, it is assumed that when N=10 and M=5, then carrier set #2 may be 6 carriers corresponding to the first 6 SLIVs in the entry #0. After determining carrier set #2, carrier set #1 may be the remaining 4 carriers corresponding to the remaining 4 SLIVs.

In yet another embodiment of the present application, the UE may determine carrier set #2 to be carriers corresponding to the last N−M+1 SLIVs in the entry of the TDRA table indicated by the DCI format. For example, it is assumed that when N=10 and M=5, then carrier set #2 may be 6 carriers corresponding to the last 6 SLIVs in the entry #0. After determining carrier set #2, carrier set #1 may be the remaining 4 carriers corresponding to the remaining 4 SLIVs.

In yet another embodiment of the present application, the UE may determine carrier set #2 to be carriers with N−M+1 lowest serving cell indexes among carriers corresponding to SLIVs in the entry of the TDRA table indicated by the DCI format. For example, it is assumed that N=10 and M=5, and the N carriers are denoted as carrier #1 to carrier #10, which correspond to cell indexes #1 to #10, respectively. Then, carrier set #2 may be carriers #1 to #6 which correspond to cell indexes #1 to #6. Carrier set #1 may be the remaining carriers #7 to #10.

In yet another embodiment of the present application, the UE may determine carrier set #2 to be carriers with N−M+1 highest serving cell indexes among carriers corresponding to SLIVs in the entry of the TDRA table indicated by the DCI format. For example, it is assumed that N=10 and M=5, and the N carriers are denoted as carrier #1 to carrier #10, which correspond to cell indexes #1 to #10, respectively. Then, carrier set #2 may be carriers #5 to #10 which correspond to cell indexes #5 to #10. Carrier set #1 may be the remaining carriers #1 to #4.

In yet another embodiment of the present application, the UE may determine one (e.g., carrier #2A) of carrier set #2 to be a carrier where the DCI format is transmitted and determine the remaining carrier(s) of carrier set #2 to be carriers immediately following carrier #2A according to a pre-defined order (e.g., an ascending order, a descending order, or any other order) of the serving cell indexes among carriers corresponding to SLIVs in the entry of the TDRA table indicated by the DCI format. For example, it is assumed that N=10 and M=5, the N carriers are denoted as carrier #1 to carrier #10, which correspond to cell indexes #1 to #10, respectively, the DCI format is transmitted on carrier #2, and the pre-defined order is an ascending order. Then, the UE may determine carrier #2A of carrier set #2 to be carrier #2, and determine the remaining 5 carriers of carrier set #2 to be carriers #3 to #7 which immediately follow carrier #2 according to an increasing order of the serving cell indexes. Carrier set #1 may be the remaining carriers #1, #8, #9, and #10.

The UE may generate a number of HARQ-ACK information bits for the number of TBs carried on carrier set #1 and carrier set #2. For example, assuming that CBG-based retransmission, spatial bundling and the maximum of 2 TBs per PDSCH are not configured, UE may generate M HARQ-ACK information bits for the M TBs. Specifically, for each TB transmitted on a carrier of carrier set #1, the UE may generate a corresponding HARQ-ACK information bit. For the same TB transmitted on carrier set #2, the UE may generate a single HARQ-ACK information bit for the TB. For example, as long as one PDSCH on one carrier of carrier set #2 is correctly received or decoded by the UE, then an ACK bit is generated for the same TB; and only when all the of PDSCHs on carrier set #2 are not correctly received or decoded, a NACK bit is generated for the same TB.

Consequently, the set of HARQ-ACK information bits includes one or more HARQ-ACK information bits for the TB(s) transmitted on carrier set #1 and a single HARQ-ACK information bit for the same TB transmitted on carrier set #2 (e.g., a total of M bits).

On one hand, various methods may be employed to be arranged the HARQ-ACK information bits in the set of HARQ-ACK information bits, which will be detailed in the following text. On the other hand, the well-arranged set of HARQ-ACK information bits may be placed in the HARQ-ACK codebook which may be multiplex with HARQ-ACK feedback for PDSCHs scheduled by two or more DCI formats according to one of the following methods and other similar methods. For example, a first HARQ-ACK information bit of the set of HARQ-ACK information bits may be placed in the HARQ-ACK codebook according to the DAI in the DCI format, and the remaining HARQ-ACK information bit(s) of the set of HARQ-ACK information bits may be placed following the first HARQ-ACK information bit.

The following embodiments provide solutions for arranging the HARQ-ACK information bits in the set of HARQ-ACK information bits.

In an embodiment of the present application, the single HARQ-ACK information bit for the same TB transmitted on carrier set #2 is placed at a pre-defined position of the set of HARQ-ACK information bits, and the one or more HARQ-ACK information bits for the TB(s) transmitted on carrier set #1 are placed according to a pre-defined order of the serving cell indexes of carrier set #1. For example, the single HARQ-ACK information bit may be placed in front of the one or more HARQ-ACK information bits, the single HARQ-ACK information bit may be placed after the one or more HARQ-ACK information bits, or the single HARQ-ACK information bit may be placed in a specific position of the one or more HARQ-ACK information bits. The pre-defined order for ordering the one or more HARQ-ACK information bits may be an ascending order, a descending order, or any other order.

For example, it is assumed that when:
N=10, the N carriers are denoted as carrier #1 to carrier #10, which correspond to cell indexes #1 to #10, respectively;
M=5, the M TBs are denoted as TB #1 to TB #5, respectively;
Carrier set #1 includes carriers #1, #8, #9, and #10, TB #1 to TB #4 are transmitted on carriers #1, #8, #9, and #10, respectively; and
Carrier set #2 includes carriers #2 to #7, TB #5 is transmitted on carriers #2 to #7.

Then, the UE may generate a single HARQ-ACK information bit for TB #5 transmitted on carriers #2 to #7, and generate 4 HARQ-ACK information bits for TBs #1 to #4, respectively. In the case that the single HARQ-ACK information bit is placed in front of the one or more HARQ-ACK information bits and the one or more HARQ-ACK information bits are placed according to an ascending order of the serving cell indexes, the set of HARQ-ACK information bits may be {a1,a2,a3,a4,a5}, where a1 is the single HARQ-ACK information bit for TB #5, and a2-a5 are HARQ-ACK information bits for TB #1, TB #2, TB #3, and TB #4, respectively.

In another other embodiment of the present application, the set of HARQ-ACK information bits is ordered according to a pre-defined order (e.g., an ascending order, a descending order, or any other order) of associated serving cell indexes of the plurality of carriers, and the single HARQ-ACK information bit is associated with a specific serving cell index (e.g., a lowest serving cell index, a highest serving cell index, or any other serving cell index) of carrier set #2.

For example, it is assumed that when:
N=10, the N carriers are denoted as carrier #1 to carrier #10, which correspond to cell indexes #1 to #10, respectively;
M=5, the M TBs are denoted as TB #1 to TB #5, respectively;
Carrier set #1 includes carriers #1, #8, #9, and #10, TB #1 to TB #4 are transmitted on carriers #1, #8, #9, and #10, respectively;
Carrier set #2 includes carriers #2 to #7, TB #5 is transmitted on carriers #2 to #7.

Then, the UE may generate a single HARQ-ACK information bit for the TB #5 transmitted on carriers #2 to #7, and generate 4 HARQ-ACK information bits for TBs #1 to #4, respectively. In the case that the set of HARQ-ACK information bits is ordered according to an ascending order of associated serving cell indexes, and the single HARQ-ACK information bit is associated with a lowest serving cell index (i.e., cell index #2) of the second set of carriers, the set of HARQ-ACK information bits may be {b1,b2,b3,b4,b5}, where b1 is the HARQ-ACK information bit for TB #1 (associated with cell index #1), b2 is the single HARQ-ACK information bit for TB #5 (associated with cell index #2), b3-b5 are the HARQ-ACK information bits for TB #2, TB #3, and TB #4 (respectively associated with cell indexes #8, #9, and #10), respectively.

In yet another embodiment of the present application, the set of HARQ-ACK information bits is included in a sub-codebook. Within the sub-codebook, the set of HARQ-ACK information bits is ordered based on the above embodiments. After determining the sub-codebook, the UE may place the sub-codebook in the HARQ-ACK codebook according to the value of the counter DAI in the DCI format.

In some embodiments of the present application, the UE may determine that the number of TBs is equal to the number of the plurality of carriers. In such embodiments, each of the plurality of carriers transmits a different TB. That is, for the plurality of TBs transmitted on the plurality of carriers, each TB is only transmitted on one carrier without carrier domain repetition. Then, for each TB transmitted on a carrier of the plurality of carriers, the UE may generate a corresponding HARQ-ACK information bit for the TB.

Consequently, the set of HARQ-ACK information bits may include the number of HARQ-ACK information bits for the number of TBs (e.g., a total of M or N bits, wherein M=N).

On one hand, various methods may be employed to be arranged the HARQ-ACK information bits in the set of HARQ-ACK information bits, which will be detailed in the following text. On the other hand, the well-arranged set of HARQ-ACK information bits may be placed in the HARQ-ACK codebook which may be multiplexed with HARQ-ACK feedback for PDSCHs scheduled by two or more DCI formats according to one of the following methods and other similar methods. For example, a first HARQ-ACK information bit of the set of HARQ-ACK information bits may be placed in the HARQ-ACK codebook according to the DAI in the DCI format, and the remaining HARQ-ACK information bit(s) of the set of HARQ-ACK information bits may be placed following the first HARQ-ACK information bit.

The following embodiments provide solutions for arranging the HARQ-ACK information bits in the set of HARQ-ACK information bits.

In some embodiments, the set of HARQ-ACK information bits may be ordered according to a pre-defined order (e.g., an ascending order, a descending order, or any other order) of associated serving cell indexes of the plurality of carriers.

For example, in an embodiment of the present application, the plurality of PDSCHs can be ordered according to a pre-defined order (e.g., an ascending order, a descending order, or any other order) of an associated serving cell index among the plurality of carriers. Then, a HARQ-ACK information bit corresponding to the first PDSCH of the ordered PDSCHs may be the first HARQ-ACK information bit of the set of HARQ-ACK information bits and is placed in the HARQ-ACK codebook according to the value of the counter DAI. After determining the first HARQ-ACK information bit, the ULE places the remaining HARQ-ACK information bits corresponding to the remaining PDSCHs according to the pre-defined order of the associated serving cell index among the plurality of carriers.

For example, it is assumed that: 10 PDSCHs may be denoted as PDSCH #1 to PDSCH #10 and may be scheduled on 10 carriers denoted as carrier #1 to carrier #10, respectively, each PDSCH may carry a different TB, and carrier #1 to carrier #10 correspond to cell indexes #1 to #10, respectively. Moreover, it is assumed that the pre-defined order is a descending order of the associated serving cell index among the plurality of carriers. The UE may generate the set of HARQ-ACK information bits as {c10,c9, . . . c1}, where c1-10 are HARQ-ACK information bits for PDSCHs #1-#10 respectively (associated with cell indexes #1-#10, respectively).

For example, in another embodiment of the present application, it is assumed that: 10 TBs (denoted as TB #1 to TB #10) are transmitted on 10 carriers denoted as carrier #1 to carrier #10, respectively; and carrier #1 to carrier #10 correspond to cell indexes #1 to #10, respectively. Moreover, it is assumed that the pre-defined order is an ascending order. Then, the set of HARQ-ACK information bits may be {d1,d2, . . . d10}, where d1-d10 are HARQ-ACK information bits for TBs #1-#10 (associated with cell indexes #1-#10, respectively).

In yet another embodiment of the present application, the set of HARQ-ACK information bits is included in a sub-codebook. Within the sub-codebook, the set of HARQ-ACK information bits is ordered based on the above embodiments. After determining the sub-codebook, the UE may place the sub-codebook in the HARQ-ACK codebook according to the value of the counter DAI in the DCI format.

In step 207, the UE may transmit the generated HARQ-ACK codebook to the BS.

The above embodiments use a TDRA table and the TDRA field in the DCI format to determine the number of TBs in step 203. However, according to some other embodiments of the present application, the DCI format may indicate whether the plurality of PDSCHs carries the same TB or each of the plurality of PDSCHs carries a different TB.

In some embodiments, the DCI format may include an indicator to indicate whether the plurality of PDSCHs carries the same TB or each of the plurality of PDSCHs carries a different TB. For example, the indicator may include one bit. The value “1” of the indicator may indicate that the plurality of PDSCHs carries the same TB, i.e., a single TB is repeated on the plurality of carriers (in other words, all the PDSCHs are carrying the same TB for the purpose of reliability improvement); the value “0” of the indicator may indicate that each of the plurality of PDSCHs carries a different TB, i.e., a plurality of TBs is transmitted on the plurality of carriers; or vice versa.

In response to receiving the DCI format, in step 203, the UE may determine the number of the TBs being equal to 1 or being equal to the number of the plurality of carriers (or the number of PDSCHs scheduled by the DCI format).

In step 205, the UE may generate a HARQ-ACK codebook. The HARQ-ACK codebook may include a set of HARQ-ACK information bits for the TBs transmitted on the plurality of PDSCHs.

In some embodiments of the present application, the set of HARQ-ACK information bits is placed in the HARQ-ACK codebook based on a DAI in the DCI format. For example, in the case that the HARQ-ACK codebook includes HARQ-ACK feedback (e.g., the set of HARQ-ACK information bits) corresponding to the plurality of PDSCHs scheduled by the DCI format and HARQ-ACK feedback corresponding to PDSCHs scheduled by one or more other DCI formats, the HARQ-ACK codebook may be determined based the DAIs in these DCI formats. For example, the size of the HARQ-ACK codebook may be determined based on the total DAI. For example, the set of HARQ-ACK information bits may be placed in the HARQ-ACK codebook based on the counter DAI in the DCI format.

In some embodiments of the present application, the UE may determine that the number of TBs transmitted on the plurality of PDSCHs is equal to 1. Then, the set of HARQ-ACK information bits for the number of TBs may only include a single HARQ-ACK information bit (e.g., ACK or NACK) for the same TB (for example, when CBG-based retransmission, spatial bundling and the maximum of 2 TBs per PDSCH are not configured). Specifically, as long as one PDSCH of the plurality of PDSCHs is correctly received or decoded by the UE, then an ACK is generated for the same TB; and only when all the plurality of PDSCHs are not correctly received or decoded, a NACK is generated for the same TB. In this case, the UE may place the single HARQ-ACK information bit in the HARQ-ACK codebook according to the value of the DAI (e.g., counter DAI) in the DCI format.

In some embodiments of the present application, the UE may determine that the number of TBs is equal to the number of the plurality of carriers (or the number of scheduled PDSCHs). In such embodiments, for each TB transmitted on a carrier of the plurality of carriers, the UE may generate a corresponding HARQ-ACK information bit for the TB.

Consequently, the set of HARQ-ACK information bits may include the number of HARQ-ACK information bits for the number of TBs. On one hand, various methods may be employed to be arranged the HARQ-ACK information bits in the set of HARQ-ACK information bits, which will be detailed in the following text. On the other hand, the well-arranged set of HARQ-ACK information bits may be placed in the HARQ-ACK codebook according to one of the following methods and other similar methods.

For example, a first HARQ-ACK information bit of the set of HARQ-ACK information bits may be placed in the HARQ-ACK codebook according to the DAI in the DCI format, and the remaining HARQ-ACK information bit(s) of the set of HARQ-ACK information bits may be placed following the first HARQ-ACK information bit.

The following embodiments provide solutions for arranging the HARQ-ACK information bits in the set of HARQ-ACK information bits.

In some embodiments, the set of HARQ-ACK information bits may be ordered according to a pre-defined order (e.g., an ascending order, a descending order, or any other order) of associated serving cell indexes of the plurality of carriers.

For example, in an embodiment of the present application, the plurality of PDSCHs can be ordered according to a pre-defined order (e.g., an ascending order, a descending order, or any other order) of an associated serving cell index among the plurality of carriers. Then, a HARQ-ACK information bit corresponding to the first PDSCH of the ordered PDSCHs may be the first HARQ-ACK information bit of the set of HARQ-ACK information bits and is placed in the HARQ-ACK codebook according to the value of the counter DAI. After determining the first HARQ-ACK information bit, the ULE places the remaining HARQ-ACK information bits corresponding to the remaining PDSCHs according to the pre-defined order of the associated serving cell index among the plurality of carriers.

In another embodiment of the present application, the set of HARQ-ACK information bits is included in a sub-codebook. Within the sub-codebook, the set of HARQ-ACK information bits is ordered based on the above embodiments. After determining the sub-codebook, the UE may place the sub-codebook in the HARQ-ACK codebook according to the value of the counter DAI in the DCI format.

In step 207, the UE may transmit the HARQ-ACK codebook to the BS.

It should be appreciated by persons skilled in the art that the sequence of the operations in exemplary procedure 200 may be changed and some of the operations in exemplary procedure 200 may be eliminated or modified, without departing from the spirit and scope of the disclosure.

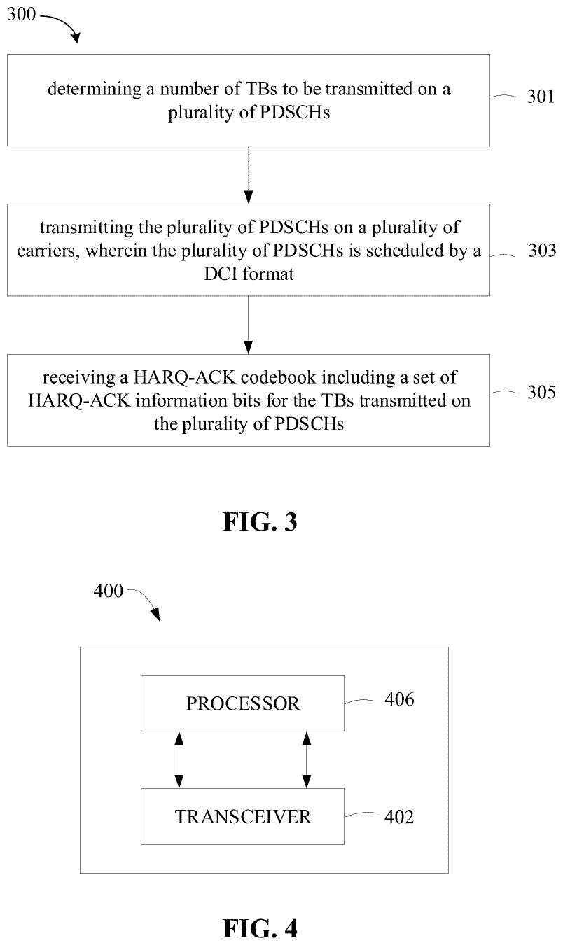

FIG. 3 is a flow chart illustrating another exemplary method 300 for HARQ-ACK codebook determination according to some other embodiments of the present application. The method in FIG. 3 may be implemented by a BS (e.g., BS 102 as shown in FIG. 1).

In the exemplary method shown in FIG. 3, in step 301, the BS may determine a number of TBs to be transmitted on a plurality of PDSCHs.

Then, in step 302, the BS may transmit the plurality of PDSCHs on a plurality of carriers to a UE (e.g., UE 101 as shown in FIG. 1). The plurality of PDSCHs may be scheduled by a DCI format (e.g., DCI format 1_0 or DCI format 1_1 as specified in 3GPP standard documents).

The number of the plurality of PDSCHs may be the same as the number of the plurality of carriers, and each PDSCH of the plurality of PDSCHs may be scheduled on a corresponding carrier of the plurality of carriers. Each carrier may correspond to a serving cell (also referred to as “a cell”) having a serving cell index (also referred to as “a cell index”).

In step 305, the BS may receive a HARQ-ACK codebook from the UE. The HARQ-ACK codebook may include a set of HARQ-ACK information bits for the TBs transmitted on the plurality of PDSCHs.

In some embodiments of the present application, the set of HARQ-ACK information bits is placed in the HARQ-ACK codebook based on a DAI in the DCI format.

For example, the DCI format may include a DAI (e.g., a counter DAI) to indicate the accumulative number of transmitted DCI formats with a cyclic redundancy check (CRC) scrambled by a cell radio network temporary identifier (C-RNTI) for scheduling a dynamic PDSCH transmission, activating semi-persistent scheduling (SPS) PDSCH transmission, releasing SPS PDSCH transmission, or indicating secondary cell (SCell) dormancy, up to a current serving cell and current PDCCH monitoring occasion. The DCI format may also include an additional DAI (e.g., a total DAI) to indicate the total number of transmitted DCI formats with CRC scrambled by a C-RNTI for scheduling a dynamic PDSCH transmission, activating SPS PDSCH transmission, releasing SPS PDSCH transmission, or indicating SCell dormancy, up to the current PDCCH monitoring occasion.

In the case that the HARQ-ACK codebook includes HARQ-ACK feedback (e.g., the set of HARQ-ACK information bits) corresponding to the plurality of PDSCHs scheduled by the DCI format and HARQ-ACK feedback corresponding to PDSCHs scheduled by one or more other DCI formats, the HARQ-ACK codebook may be determined based the DAIs in these DCI formats. For example, the size of the HARQ-ACK codebook may be determined based on the total DAI. For example, the set of HARQ-ACK information bits may be placed in the HARQ-ACK codebook based on the counter DAI in the DCI format.

According to some embodiments of the present application, the BS may transmit a TDRA table to the UE such that the UE may determine the number of TBs scheduled by a DCI format based on the TDRA table. The descriptions of TDRA table with respect to FIG. 2 may apply here and thus are omitted herein.

The DCI format scheduling the plurality of PDSCHs (e.g., a TDRA field in a DCI format) may indicate an entry (e.g., entry #0) of the TDRA table. The entry #0 may indicate the number of TBs transmitted on the plurality of PDSCHs, multiple SLIVs, at least one slot offset value associated with the multiple SLIVs, and at least one PDSCH mapping type associated with the multiple SLIVs. Each SLIV may be associated with a corresponding PDSCH on a carrier of the plurality of carriers.

In some embodiments of the present application, the number of TBs transmitted on the plurality of PDSCHs is equal to 1. Then, the set of HARQ-ACK information bits for the number of TBs may only include a single HARQ-ACK information bit (e.g., ACK or NACK) for the same TB (for example, when CBG-based retransmission, spatial bundling and the maximum of 2 TBs per PDSCH are not configured). In this case, the single HARQ-ACK information bit is placed in the HARQ-ACK codebook according to the value of the counter DAI in the DCI format.

In some other embodiments of the present application, the number of TBs is larger than 1 and smaller than the number of the plurality of carriers. In such embodiments, the plurality of carriers may include a set of carriers (carrier set #1′), each of which carries a different TB, and another set of carriers (carrier set #2′), each of which carries the same TB. Carrier set #1′ may include X carriers of the plurality of carriers and X equals the number of TBs minus 1. Carrier set #2′ may include the remaining carriers of the plurality of carriers, and the number of carriers in carrier set #2′ is denoted as Y for clarity.

For example, it is assumed that an entry (e.g., entry #0) indicated by the DCI format indicates M TBs and N SLIVs (each SLIV may correspond to a corresponding carrier). Carrier set #1′ may include M−1 carriers (i.e., X=M−1), each of which carries a different TB, and carrier set #2′ may include N−M+1 carriers (i.e., Y=N−M+1), each of which carries the same TB (e.g., carrying a TB repetition of the same TB).

Carrier set #1′ and carrier set #2′ may be determined by at least one of the following embodiments.

In some embodiments of the present application, carrier set #1′ or carrier set #2′ may be carriers corresponding to certain specific SLIVs in the entry of the TDRA table indicated by the DCI format.

For example, in an embodiment of the present application, carrier set #1′ are carriers corresponding to the first M−1 SLIVs in the entry of the TDRA table indicated by the DCI format.

In another embodiment of the present application, carrier set #1′ are carriers corresponding to the last M−1 SLIVs in the entry of the TDRA table indicated by the DCI format.

In yet another embodiment of the present application, carrier set #1′ are carriers with M−1 lowest serving cell indexes among carriers corresponding to SLIVs in the entry of the TDRA table indicated by the DCI format.

In yet another embodiment of the present application, carrier set #1′ are carriers with M−1 highest serving cell indexes among carriers corresponding to SLIVs in the entry of the TDRA table indicated by the DCI format.

In yet another embodiment of the present application, one (e.g., carrier #1A′) of carrier set #1′ is a carrier where the DCI format is transmitted and the remaining carrier(s) of carrier set #1′ are carriers immediately following carrier #1A′ according to a pre-defined order (e.g., an ascending order, an descending order, or any other order) of the serving cell indexes among carriers corresponding to SLIVs in the entry of the TDRA table indicated by the DCI format.

In yet another embodiment of the present application, carrier set #2′ are carriers corresponding to the first N−M+1 SLIVs in the entry of the TDRA table indicated by the DCI format.

In yet another embodiment of the present application, carrier set #2′ are carriers corresponding to the last N−M+1 SLIVs in the entry of the TDRA table indicated by the DCI format.

In yet another embodiment of the present application, carrier set #2′ are carriers with N−M+1 lowest serving cell indexes among carriers corresponding to SLIVs in the entry of the TDRA table indicated by the DCI format.

In yet another embodiment of the present application, carrier set #2′ are carriers with N−M+1 highest serving cell indexes among carriers corresponding to SLIVs in the entry of the TDRA table indicated by the DCI format.

In yet another embodiment of the present application, one (e.g., carrier #2A′) of carrier set #2′ is a carrier where the DCI format is transmitted and the remaining carrier(s) of carrier set #2′ are carriers immediately following carrier #2A′ according to a pre-defined order (e.g., an ascending order, a descending order, or any other order) of the serving cell indexes among carriers corresponding to SLIVs in the entry of the TDRA table indicated by the DCI format.

In such case, in some examples, the set of HARQ-ACK information bits includes one or more HARQ-ACK information bits for the TB(s) transmitted on carrier set #1′ and a single HARQ-ACK information bit for the same TB transmitted on carrier set #2′.

On one hand, the HARQ-ACK information bits in the set of HARQ-ACK information bits may be arranged according to various methods, which will be detailed in the following text. On the other hand, the well-arranged set of HARQ-ACK information bits may be placed in the HARQ-ACK codebook according to one of the following methods and other similar methods.

For example, a first HARQ-ACK information bit of the set of HARQ-ACK information bits may be placed in the HARQ-ACK codebook according to the DAI in the DCI format, and the remaining HARQ-ACK information bit(s) of the set of HARQ-ACK information bits may be placed following the first HARQ-ACK information bit.

The following embodiments describe how the HARQ-ACK information bits are arranged in the set of HARQ-ACK information bits.

In an embodiment of the present application, the single HARQ-ACK information bit for the same TB transmitted on carrier set #2′ is placed at a pre-defined position of the set of HARQ-ACK information bits, and the one or more HARQ-ACK information bits for the TB(s) transmitted on carrier set #1′ are placed according to a pre-defined order of the serving cell indexes of carrier set #1′. For example, the single HARQ-ACK information bit may be placed in front of the one or more HARQ-ACK information bits, the single HARQ-ACK information bit may be placed after the one or more HARQ-ACK information bits, or the single HARQ-ACK information bit may be placed in a specific position of the one or more HARQ-ACK information bits. The pre-defined order may be an ascending order, a descending order, or any other order.

In another embodiment of the present application, the set of HARQ-ACK information bits is ordered according to a pre-defined order (e.g., an ascending order, a descending order, or any other order) of associated serving cell indexes of the plurality of carriers, and the single HARQ-ACK information bit is associated with a specific serving cell index (e.g., a lowest serving cell index, a highest serving cell index, or any other serving cell index) of carrier set #2′.

In yet another embodiment of the present application, the set of HARQ-ACK information bits is included in a sub-codebook. Within the sub-codebook, the set of HARQ-ACK information bits is ordered based on the above embodiments. The sub-codebook is placed in the HARQ-ACK codebook according to the value of the counter DAI in the DCI format.

In some other embodiments of the present application, the number of TBs is equal to a number of the plurality of carriers. In such embodiments, each of the plurality of carriers transmits a different TB. That is, for the plurality of TBs transmitted on the plurality of carriers, each TB is only transmitted on one carrier without carrier domain repetition. Consequently, the set of HARQ-ACK information bits may include the number of HARQ-ACK information bits for the number of TBs, wherein each HARQ-ACK information bit may be for a corresponding TB.

On one hand, the HARQ-ACK information bits in the set of HARQ-ACK information bits may be arranged according to various methods, which will be detailed in the following text.

On the other hand, the well-arranged set of HARQ-ACK information bits may be placed in the HARQ-ACK codebook according to one of the following methods and other similar methods. For example, a first HARQ-ACK information bit of the set of HARQ-ACK information bits may be placed in the HARQ-ACK codebook according to the DAI in the DCI format, and the remaining HARQ-ACK information bit(s) of the set of HARQ-ACK information bits may be placed following the first HARQ-ACK information bit.

The following embodiments provide solutions for arranging the HARQ-ACK information bits in the set of HARQ-ACK information bits.

In some embodiments, the set of HARQ-ACK information bits may be ordered according to a pre-defined order (e.g., an ascending order, a descending order, or any other order) of associated serving cell indexes of the plurality of carriers.

For example, in an embodiment of the present application, the plurality of PDSCHs can be ordered according to a pre-defined order (e.g., an ascending order, a descending order, or any other order) of an associated serving cell index among the plurality of carriers. Then, a HARQ-ACK information bit corresponding to the first PDSCH of the ordered PDSCHs may be the first HARQ-ACK information bit of the set of HARQ-ACK information bits and is placed in the HARQ-ACK codebook according to the value of the counter DAI. After determining the first HARQ-ACK information bit, the BS may determine that the remaining HARQ-ACK information bits corresponding to the remaining PDSCHs are placed in the HARQ-ACK codebook according to the pre-defined order of the associated serving cell index among the plurality of carriers.

In another embodiment of the present application, the set of HARQ-ACK information bits is included in a sub-codebook. Within the sub-codebook, the set of HARQ-ACK information bits is ordered based on the above embodiments. The sub-codebook is placed in the HARQ-ACK codebook according to the value of the counter DAI in the DCI format.

In the above embodiments, a TDRA table may be configured to the UE to determine the number of TBs. However, according to some other embodiments of the present application, the DCI format may indicate whether the plurality of PDSCHs carries the same TB or each of the plurality of PDSCHs carries a different TB.

In some embodiments, the DCI format may include an indicator to indicate whether the plurality of PDSCHs carries the same TB or each of the plurality of PDSCHs carries a different TB. For example, the indicator may include one bit. The value “1” of the indicator may indicate that the plurality of PDSCHs carries the same TB, i.e., a single TB is repeated on the plurality of carriers (in other words, all the PDSCHs are carrying a same TB for the purpose of reliability improvement); the value “0” of the indicator may indicate that each of the plurality of PDSCHs carries a different TB, i.e., a plurality of TBs is transmitted on the plurality of carriers; or vice versa.

In such embodiments, the number of the TBs transmitted on the plurality of PDSCHs may be equal to 1 or equal to the number of the plurality of carriers (or the number of PDSCHs scheduled by the DCI format).

In some embodiments of the present application, the number of TBs transmitted on the plurality of PDSCHs may be equal to 1. Then, the set of HARQ-ACK information bits for the number of TBs may only include a single HARQ-ACK information bit (e.g., ACK or NACK) for the same TB (for example, when CBG-based retransmission, spatial bundling and the maximum of 2 TBs per PDSCH are not configured). The single HARQ-ACK information bit is placed in the HARQ-ACK codebook according to the value of the counter DAI in the DCI format.

In some other embodiments of the present application, the number of TBs may be equal to the number of the plurality of carriers (or the number of scheduled PDSCHs). In such embodiments, the set of HARQ-ACK information bits may include the number of HARQ-ACK information bits for the number of TBs, wherein each HARQ-ACK information bit may be for a corresponding TB.

On one hand, the HARQ-ACK information bits in the set of HARQ-ACK information bits may be arranged according to various methods, which will be detailed in the following text.

On the other hand, the well-arranged set of HARQ-ACK information bits may be placed in the HARQ-ACK codebook according to one of the following methods and other similar methods. For example, a first HARQ-ACK information bit of the set of HARQ-ACK information bits may be placed in the HARQ-ACK codebook according to the DAI in the DCI format, and the remaining HARQ-ACK information bit(s) of the set of HARQ-ACK information bits may be placed following the first HARQ-ACK information bit.

The following embodiments provide solutions for arranging the HARQ-ACK information bits in the set of HARQ-ACK information bits.

In some embodiments, the set of HARQ-ACK information bits may be ordered according to a pre-defined order (e.g., an ascending order, a descending order, or any other order) of associated serving cell indexes of the plurality of carriers.

For example, in an embodiment of the present application, the plurality of PDSCHs can be ordered according to a pre-defined order (e.g., an ascending order, a descending order, or any other order) of an associated serving cell index among the plurality of carriers. Then, a HARQ-ACK information bit corresponding to the first PDSCH of the ordered PDSCHs may be the first HARQ-ACK information bit of the set of HARQ-ACK information bits and is placed in the HARQ-ACK codebook according to the value of the counter DAI. After determining the first HARQ-ACK information bit, the BS may determine that the remaining HARQ-ACK information bits corresponding to the remaining PDSCHs are placed in the HARQ-ACK codebook according to the pre-defined order of the associated serving cell index among the plurality of carriers.

In another embodiment of the present application, the set of HARQ-ACK information bits is included in a sub-codebook. Within the sub-codebook, the set of HARQ-ACK information bits is ordered based on the above embodiments. The sub-codebook is placed in the HARQ-ACK codebook according to the value of the counter DAI in the DCI format.

It should be appreciated by persons skilled in the art that the sequence of the operations in exemplary procedure 300 may be changed and some of the operations in exemplary procedure 300 may be eliminated or modified, without departing from the spirit and scope of the disclosure.

Although in the embodiments of FIGS. 2 and 3, it is assumed that one PDSCH only carries one TB, it should be appreciated by persons skilled in the art that the methods in FIGS. 2 and 3 may also be applied to the cases that one PDSCH carries more than one TB.

For examples, when each PDSCH can carry K different TBs, if each of the two or more PDSCHs carries the same K TBs, K HARQ-ACK information bits (instead of a single HARQ-ACK information bit as described above) may be generated for the two or more PDSCHs (for example, when code block group (CBG) based retransmission, spatial bundling are not configured).

In the case that the number of PDSCHs required for carrying the number of TBs (e.g., M/K, wherein M denotes the number of TBs scheduled by a DCI format, which may be determined according to the TDRA table as described above) is equal to 1 or the DCI format indicates that each of the plurality of scheduled PDSCHs carry the same K TBs, a set of HARQ-ACK information bits including K HARQ-ACK information bits may be generated for the repeatedly transmitted K TBs. The set of HARQ-ACK information bits may be placed in the HARQ-ACK codebook based on the DAI in the DCI format.

In the case that the number of PDSCHs required for carrying the number of TBs (e.g., M/K) is larger than 1 and smaller than the number of PDSCHs scheduled the DCI format, the plurality of carriers scheduled the DCI format may include carrier set #1″, each of which carries different K TBs, and carrier set #2″, each of which carries the same K TBs. The methods for determining the carrier sets in the embodiments of FIG. 2 and FIG. 3 may also be applied herein. Moreover, in such embodiments, the set of HARQ-ACK information bits may include HARQ-ACK information bits for the TBs transmitted on carrier set #1″ and HARQ-ACK information bits (e.g., K bits) for the same TBs transmitted carrier set #2″. The methods for arranging the HARQ-ACK information bits of the set of HARQ-ACK information bits in the embodiments of FIG. 2 and FIG. 3 may also be applied herein.

In the case that the number of PDSCHs required for carrying the number of TBs (e.g., M/K) is equal to the number of the plurality of scheduled PDSCHs or the DCI format indicates that the plurality of scheduled PDSCHs carry different TBs, for each PDSCH, the corresponding K HARQ-ACK information bits may be generated. The set of HARQ-ACK information bits may include K*N=M bits, where N denotes the number of the plurality of scheduled carriers or PDSCHs. The methods for arranging the HARQ-ACK information bits of the set of HARQ-ACK information bits in the embodiments of FIG. 2 and FIG. 3 may also be applied herein.

FIG. 4 illustrates a block diagram of an exemplary apparatus 400 according to some embodiments of the present disclosure. As shown in FIG. 4, the apparatus 400 may include at least one processor 406 and at least one transceiver 402 coupled to the processor 406. The apparatus 400 may be a UE or a BS.

Although in this figure, elements such as the at least one transceiver 402 and processor 406 are described in the singular, the plural is contemplated unless a limitation to the singular is explicitly stated. In some embodiments of the present application, the transceiver 402 may be divided into two devices, such as a receiving circuitry and a transmitting circuitry. In some embodiments of the present application, the apparatus 400 may further include an input device, a memory, and/or other components.

In some embodiments of the present application, the apparatus 400 may be a UE. The transceiver 402 and the processor 406 may interact with each other so as to perform the operations with respect to the UE described in FIGS. 1-3. In some embodiments of the present application, the apparatus 400 may be a BS. The transceiver 402 and the processor 406 may interact with each other so as to perform the operations with respect to the BS described in FIGS. 1-3.

In some embodiments of the present application, the apparatus 400 may further include at least one non-transitory computer-readable medium.

For example, in some embodiments of the present disclosure, the non-transitory computer-readable medium may have stored thereon computer-executable instructions to cause the processor 406 to implement the method with respect to the UE as described above. For example, the computer-executable instructions, when executed, cause the processor 406 interacting with transceiver 402 to perform the operations with respect to the UE described in FIGS. 1-3.

In some embodiments of the present disclosure, the non-transitory computer-readable medium may have stored thereon computer-executable instructions to cause the processor 406 to implement the method with respect to the BS as described above. For example, the computer-executable instructions, when executed, cause the processor 406 interacting with transceiver 402 to perform the operations with respect to the BS described in FIGS. 1-3.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
receive a plurality of physical downlink shared channels (PDSCHs) on a plurality of carriers, wherein the plurality of PDSCHs is scheduled by a downlink control information (DCI) format;
determine a number of transport blocks (TBs) transmitted on the plurality of PDSCHs based on the DCI format;
generate a hybrid automatic repeat request acknowledgement (HARQ-ACK) codebook including a set of HARQ-ACK information bits for the TBs transmitted on the plurality of PDSCHs; and
transmit the HARQ-ACK codebook.

2. The UE of claim 1, wherein the at least one processor is further configured to cause the UE to: receive a time domain resource allocation (TDRA) table, wherein a first entry of the TDRA table indicates multiple start and length indicator values (SLIVs), at least one slot offset value associated with the multiple SLIVs, and at least one PDSCH mapping type associated with the multiple SLIVs, and wherein each SLIV is associated with a corresponding PDSCH on a carrier of the plurality of carriers, wherein the first entry of the TDRA table further indicates a number of TBs.

3. The UE of claim 2, wherein the DCI format indicates the first entry of the TDRA table and wherein the at least one processor is further configured to cause the UE to determine the number of TBs based on the first entry.

4. The UE of claim 1, wherein the DCI format indicates whether the plurality of PDSCHs carries the same TB or each of the plurality of PDSCHs carries a different TB.

5. The UE of claim 1, wherein the set of HARQ-ACK information bits is placed in the HARQ-ACK codebook based on a downlink assignment indicator (DAI) in the DCI format, wherein a first HARQ-ACK information bit of the set of HARQ-ACK information bits is placed in the HARQ-ACK codebook according to the DAI in the DCI format, and the remaining HARQ-ACK information bits of the set of HARQ-ACK information bits are placed following the first HARQ-ACK information bit.

6. The UE of claim 1, wherein, in response to determining the number of TBs being equal to 1, the set of HARQ-ACK information bits only includes a HARQ-ACK information bit for the TB transmitted on the plurality of PDSCHs.

7. The UE of claim 1, wherein, in response to determining the number of TBs being larger than 1 and smaller than a number of the plurality of carriers, the plurality of carriers includes a first set of carriers each of which carries a different TB, and a second set of carriers each of which carries a same TB, wherein the first set of carriers includes X carriers of the plurality of carriers and the second set of carriers includes the remaining carriers of the plurality of carriers, and wherein X equals the number of TBs minus 1.

8. The UE of claim 7, wherein the at least one processor is further configured to cause the UE to perform at least one of the following:
determine the first set of carriers to be carriers corresponding to the first X start and length indicator values (SLIVs) in an entry of a time domain resource allocation (TDRA) table indicated by the DCI format;
determine the first set of carriers to be carriers corresponding to the last X SLIVs in the entry of the TDRA table indicated by the DCI format;
determine the first set of carriers to be carriers with X lowest serving cell indexes among carriers corresponding to SLIVs in the entry of the TDRA table indicated by the DCI format;
determine the first set of carriers to be carriers with X highest serving cell indexes among carriers corresponding to SLIVs in the entry of the TDRA table indicated by the DCI format;
determine a first carrier of the first set of carriers to be a carrier where the DCI format is transmitted and determine the remaining carrier(s) of the first set of carriers to be carriers immediately following the first carrier according to a pre-defined order of the serving cell indexes among carriers corresponding to SLIVs in the entry of the TDRA table indicated by the DCI format;
determine the second set of carriers to be carriers corresponding to the first Y SLIVs in the entry of the TDRA table indicated by the DCI format, wherein Y is the number of carriers in the second set of carriers;
determine the second set of carriers to be carriers corresponding to the last Y SLIVs in the entry of the TDRA table indicated by the DCI format;
determine the second set of carriers to be carriers with Y lowest serving cell indexes among carriers corresponding to SLIVs in the entry of the TDRA table indicated by the DCI format;
determine the second set of carriers to be carriers with Y highest serving cell indexes among carriers corresponding to SLIVs in the entry of the TDRA table indicated by the DCI format; or
determine a second carrier of the second set of carriers to be a carrier where the DCI format is transmitted and determine the remaining carriers of the second set of carriers to be carriers immediately following the second carrier according to a pre-defined order of serving cell indexes among carriers corresponding to SLIVs in the entry of the TDRA table indicated by the DCI format.

9. The UE of claim 7, wherein the set of HARQ-ACK information bits includes a first HARQ-ACK information bit for the TB transmitted on the first set of carriers and a second HARQ-ACK information bit for the same TB transmitted on the second set of carriers.

10. The UE of claim 9, wherein the second HARQ-ACK information bit is placed at a pre-defined position of the set of HARQ-ACK information bits, and wherein the first HARQ-ACK information bit is placed according to a pre-defined order of the serving cell indexes of the first set of carriers.

11. The UE of claim 8, wherein the set of HARQ-ACK information bits is ordered according to a pre-defined order of associated serving cell indexes of the plurality of carriers, and wherein the second HARQ-ACK information bit is associated with a specific serving cell index of the second set of carriers.

12. The UE of claim 1, wherein in response to determining the number of TBs being equal to a number of the plurality of carriers, the set of HARQ-ACK information bits is ordered according to a pre-defined order of associated serving cell indexes of the plurality of carriers.

13. The UE of claim 9, wherein the set of HARQ-ACK information bits is included in a sub-codebook.

14. A base station (BS) for wireless communication, comprising:
at least one memory, and
at least one processor coupled with the at least one memory and configured to cause the BS to
determine a number of transport blocks (TBs) to be transmitted on a plurality of physical downlink shared channels (PDSCHs);
transmit the plurality of PDSCHs on a plurality of carriers, wherein the plurality of PDSCHs is scheduled by a downlink control information (DCI) format; and
receive a hybrid automatic repeat request acknowledgement (HARQ-ACK) codebook including a set of HARQ-ACK information bits for the TBs transmitted on the plurality of PDSCHs.

15. A method performed by a user equipment (UE), the method comprising:
receiving a plurality of physical downlink shared channels (PDSCHs) on a plurality of carriers, wherein the plurality of PDSCHs is scheduled by a downlink control information (DCI) format;
determining a number of transport blocks (TBs) transmitted on the plurality of PDSCHs based on the DCI format;
generating a hybrid automatic repeat request acknowledgement (HARQ-ACK) codebook including a set of HARQ-ACK information bits for the TBs transmitted on the plurality of PDSCHs; and
transmitting the HARQ-ACK codebook.

16. The method of claim 15, further comprising:
receiving a time domain resource allocation (TDRA) table, wherein a first entry of the TDRA table indicates multiple start and length indicator values (SLIVs), at least one slot offset value associated with the multiple SLIVs, and at least one PDSCH mapping type associated with the multiple SLIVs, and wherein each SLIV is associated with a corresponding PDSCH on a carrier of the plurality of carriers, wherein the first entry of the TDRA table further indicates a number of TBs.

17. A processor for wireless communication, comprising:
at least one controller coupled with the at least one memory and configured to cause the processor to:
receive a plurality of physical downlink shared channels (PDSCHs) on a plurality of carriers, wherein the plurality of PDSCHs is scheduled by a downlink control information (DCI) format;
determine a number of transport blocks (TBs) transmitted on the plurality of PDSCHs based on the DCI format;
generate a hybrid automatic repeat request acknowledgement (HARQ-ACK) codebook including a set of HARQ-ACK information bits for the TBs transmitted on the plurality of PDSCHs; and
transmit the HARQ-ACK codebook.

18. The processor of claim 17, wherein the at least one controller is further configured to cause the processor to: receive a time domain resource allocation (TDRA) table, wherein a first entry of the TDRA table indicates multiple start and length indicator values (SLIVs), at least one slot offset value associated with the multiple SLIVs, and at least one PDSCH mapping type associated with the multiple SLIVs, and wherein each SLIV is associated with a corresponding PDSCH on a carrier of the plurality of carriers, wherein the first entry of the TDRA table further indicates a number of TBs.

19. The processor of claim 17, wherein the DCI format indicates whether the plurality of PDSCHs carries the same TB or each of the plurality of PDSCHs carries a different TB.

20. The processor of claim 17, wherein the set of HARQ-ACK information bits is placed in the HARQ-ACK codebook based on a downlink assignment indicator (DAI) in the DCI format, wherein a first HARQ-ACK information bit of the set of HARQ-ACK information bits is placed in the HARQ-ACK codebook according to the DAI in the DCI format, and the remaining HARQ-ACK information bits of the set of HARQ-ACK information bits are placed following the first HARQ-ACK information bit.
